(19) United States
(12) Patent Application Publication
(10) Pub. No.: US 2010/0010683 A1
(43) Pub. Date: Jan. 14, 2010

(54) METHOD AND APPARATUS FOR POWER-LIMITING ELECTRICAL ACCESS

(76) Inventor: Lawrence Kates, Corona Del Mar, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/172,868

(22) Filed: Jul. 14, 2008

(51) Int. Cl. G06F 19/00

(52) U.S. Cl. 700/293

(57) ABSTRACT

A system for load control in an electrical power system is described, wherein one or more load-limiting devices such as outlets and/or lighting sockets are provided to a home or building. The load-limiting devices conserve power and increase safety by not allowing a user to attach a device that draws excess power. Unlike circuit breakers and fuses, the load-limiting devices automatically resume normal operation when the excess load is removed. In one embodiment, the power authority sends commands to tell the load-monitoring device to provide reduced power service. In one embodiment, the commands are time-limited, thereby allowing the electric power device system to resume normal operation after a specified period of time. In one embodiment, the commands include query commands to cause the control device to report operating characteristics (e.g., efficiency, time of operation, etc.) back to the power authority.

### BACKGROUND

1. Field of the Invention

The invention relates to systems for reducing load on an electric power system to avoid brownouts and blackouts.

2. Description of the Related Art

The increasing demand for electrical energy often produces overload conditions on many electric power distribution systems, particularly during periods of extreme temperatures when consumers are calling for high levels of energy to satisfy their cooling needs. When the customers' demand for energy reaches a given high level, communities are forced to endure rolling blackouts.

Severe power shortages increase the risk of damage to electrical and electronic equipment. Brownouts can occur at times of extremely high power consumption or power shortages when electric utilities reduce the voltage supply to conserve energy. Brownouts can cause computer resets, memory loss, data loss, and in some cases, overheat electronic equipment components. Motors (e.g., fan motors and air-conditioner compressor motors compressors) can also overheat and burn out. Blackouts are sustained power interruptions caused by overloads, storms, accidents, malfunctions of utility equipment, or other factors. Longer-term power outages can last from hours to days.

At present, the typical procedure often used to prevent brownouts and widespread blackouts is to institute rolling blackouts. Rolling blackouts reduce the stress on the electrical power grid, but they are very disruptive to businesses and personal lives. Electrical and electronic equipment is often damaged after a utility brownout or blackout when the power is turned back on and a burst of electricity surges through the lines. Equipment can fail because of a sudden lack of power, lower voltage levels, power surges when service is restored.

### SUMMARY

In one embodiment, an electrically-controlled switch configured to control electric power provided to an electric socket. A current sensor (or other power measuring device) measures electrical current provided by the electric socket. A processing system that opens the electrically-controlled switch to interrupt power provided by the electric socket when electrical current provided by the electric socket exceeds a threshold current for a specified period of time, the processing system configured to close the electrically-controlled switch after the electrically-controlled switch has been open for a specified period of time.

In one embodiment, the threshold current is provided to the processing system via power-line networking. In one embodiment, the processing system opens the electrically-controlled switch on receipt of a command to shutdown for a specified period of time.

In one embodiment, a data interface receives communications and provides communication data to the processing system. In one embodiment, the data interface device comprises a broadband over power line modem. In one embodiment, the data interface device comprises a wireless modem. In one embodiment, the data interface device comprises a computer network interface. In one embodiment, the data interface device comprises a powerline modem.

In one embodiment, the processing system measures power provided by the electric socket.

In one embodiment, the processing system opens the electrically-operated switch and does not subsequently automatically close the electrically-operated switch if current through the socket exceeds a maximum value.

The socket can be, for example, a socket for a standard screw-in light bulb, a three-pronged electrical outlet, a two-pronged electrical outlet, etc.

In one embodiment, a manual reset switch is provided. In one embodiment, a visual indicator to show that the electrically-controlled switch has been opened. In one embodiment, the processing system compares current provided by the socket to the maximum current after a specified time period. In one embodiment, the processing system opens the electrically-controlled switch after a specified amount of power has been provided by the socket during a specified time period. In one embodiment, the processing system activates a visual indicator after a specified amount of power has been provided by the socket during a specified time period.

In one embodiment, the specified time period comprises an initial inrush period. In one embodiment, the processing device waits a first period of time after activating a visual indicator before opening the electrically-controlled switch. In one embodiment, the processing system sends a first message to at least one load-control device before opening the electrically-controlled switch.

Other problems are solved by a system for load control in an electrical power system where one or more load-control devices are provided to reduce system load by selectively shutting down relatively high-load equipment such as, for example, air-conditioning systems, a refrigeration systems, a pool pump systems, electric ovens, and the like. The load control devices are configured to receive commands for controlling the relatively high-load system. A power authority, such as a power utility, governmental agency, power transmission company, and/or authorized agent of any such bodies, sends one or more commands to the data interfaced devices to adjust loading on the electrical power system. The ability to remotely shut down electrical equipment allows the power authority to provide an orderly reduction of power usage. Power surges can be avoided because the remote shutdown facility can schedule a staggered restart of the controlled equipment. The power load can be reduced in an intelligent manner that minimizes the impact on businesses and personal lives. In one embodiment, power usage is reduced by first shutting down relatively less important equipment, such as, for example, pool filter pumps, hot water heaters, electric ovens, etc. If further reduction in load is required, the system can also shut down relatively more important equipment such as, for example, refrigerators, air-conditioners, and the like on a rolling basis. Relatively less important equipment (and other equipment that can be run during the night or other low-load periods) such as pool filter pumps can be shut down for extended periods of time.

In one embodiment, the system shuts down electrical equipment devices according to a device type (e.g., pool pump, oven, hot water heater, air-conditioner, etc.). In one embodiment, the system shuts down electrical equipment by device type in an order that corresponds to the relative importance of the device. In one embodiment, the system shuts down electrical equipment for a selected period of time. In one embodiment, the time period varies according to the type of device. In one embodiment, relatively less important devices are shut down for longer periods than relatively more important device.

In one embodiment, the system sends commands to instruct electrical devices to operate in a low-power mode (or high-efficiency mode) before sending a full shutdown commands.

In one embodiment, the power authority sends shutdown commands. In one embodiment, the power authority sends commands to instruct the high-load system to operate in a relatively low-power mode. In one embodiment, the commands are time-limited, thereby allowing the electrical equipment to resume normal operation after a specified period of time. In one embodiment, the commands include query commands to cause the high-load system to report operating characteristics (e.g., efficiency, time of operation, etc.) back to the power authority.

In one embodiment, the system sends shutdown and startup commands. In one embodiment, the system sends shutdown commands that instruct electrical equipment to shut down for a specified period of time. In one embodiment, the shutdown time is randomized to reduce power surges when equipment restarts.

In one embodiment, power line data transmission (also referred to as current-carrier transmission) is used to send commands, (e.g., shutdown commands, startup commands, etc.). In one embodiment, a signal injector injects power line data transmission signals onto a power line.

In one embodiment, a signal injector is provided at a transformer and when loading on the transformer becomes too high, the signal injector sends commands to shut down selected equipment downstream of the transformer in order to reduce the load on the transformer.

In one embodiment, a load-control device controls power to a relatively high-load device. In one embodiment, a load-control and power-monitoring device controls power to a relatively high-load device and monitors power provided to the device. In one embodiment, a load-control device controls a relatively high-load device using relatively low power control, such as, for example, thermostat control lines. In one embodiment, a load-control and power-monitoring device controls power to a relatively high-load device and monitors current on multiple phases. In one embodiment, a load-control and power-monitoring device controls power to a relatively high-load device and that provides circuit breaker overload protection. In one embodiment, a load-control and power-monitoring device controls power to a relatively high-load device and provides circuit breaker overload protection with electric trip. In one embodiment, a single-phase load-control and power-monitoring device controls power to a relatively high-load device.

In one embodiment, a display system provides monitoring of electrical devices and/or displays messages from a power authority.

In one embodiment, a power meter provides load control capability. In one embodiment, a load control module is configured for use in connection with a standard power meter.

In one embodiment, an electric distribution system provides with automatic downstream load control.

### BRIEF DESCRIPTION OF THE DRAWINGS

FIG. 1 shows a power distribution system for a home or commercial structure.

FIG. 2A shows a power distribution system for a home or commercial structure wherein an injector provides power line communications.

FIG. 2B shows a power distribution system for a home or commercial structure wherein load-control modules are provided to allow the power authority to shed power system loads by remotely switching off certain electrical equipment.

FIG. 3 shows a load-control device that controls power to a relatively high-load device.

FIG. 4 shows a load-control and power-monitoring device that controls power to a relatively high-load device.

FIG. 5 shows a load-control device for controlling a relatively high-load device using relatively low power control, such as, for example, thermostat control lines.

FIG. 6 shows a display system for monitoring electrical devices and/or for receiving messages from a power authority.

FIG. 7 shows a load-control and power-monitoring device that controls power to a relatively high-load device and monitors current on multiple phases.

FIG. 8 shows a load-control and power-monitoring device that controls power to a relatively high-load device and that provides circuit breaker overload protection.

FIG. 9 shows a load-control and power-monitoring device that controls power to a relatively high-load device and that provides circuit breaker overload protection with electric trip.

FIG. 10 shows a single-phase load-control and power-monitoring device that controls power to a relatively high-load device.

FIG. 11 shows a conventional power meter.

FIG. 12 shows a power meter with load control capability.

FIG. 13 shows a load control module for use in connection with a standard power meter.

FIG. 14 shows an electric distribution system with automatic downstream load control.

FIG. 15 shows a power-monitoring light socket.

FIG. 16 shows a power-monitoring electrical outlet.

### DETAILED DESCRIPTION

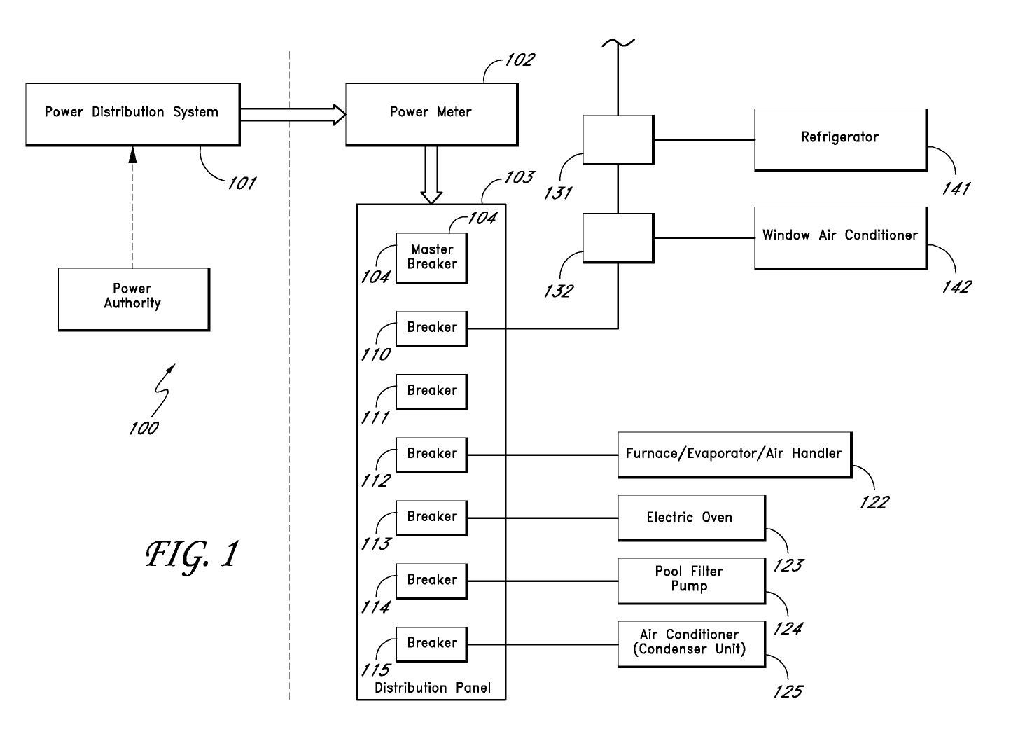

FIG. 1 shows an electrical system 100 for a home or commercial structure. In the system 100, electrical power from a distribution system 101 is provided to a power meter 102. The power meter 102 measures electrical power provided to a distribution panel 103. In the distribution panel 103, power from the meter 102 is provided to a master circuit breaker 104. Electrical power from the master circuit breaker 104 is provided to various branch circuit breakers 110-115. The branch circuit breakers 110-115 provide electric power to various branch circuits in the home or commercial structure. It is common practice to provide a dedicated branch circuit breaker to relatively high-load devices, such as, for example, electric dryers, electric ovens, electric ranges, electric water heaters, electric furnaces, building air-conditioners, pool filter pumps, etc. Thus, for example, in FIG. 1, the breaker 112 provides electrical power to a furnace/evaporator/air-handler unit, the breaker 113 provides power to an electric oven 123, the breaker 114 provides power to a pool filter pump 124, and the breaker 115 provides power to an air-conditioner condenser unit 125. The relatively high-load devices on dedicated circuit breakers are typically devices that operate at higher voltage (e.g., on 220 volts in the U.S.) and thus the dedicated circuit breakers 112-115 are typically double-pole breakers that switch both “hot” lines in a split-phase system.

The breaker 110 provides electrical power to a string of electrical outlets 131-132. It is also common practice to provide a single branch circuit breaker to a plurality of electrical outlets for powering relatively low-load electrical devices (e.g., computers, window air-conditioners, refrigerators, lights, entertainment systems, etc.). Thus, for example, FIG. 1 shows a refrigerator 141 plugged into the electrical outlet 131 and a window air-conditioner unit plugged into the electrical outlet 132.

The individual electric power provided to the relatively high-load devices connected to dedicated breakers can be controlled at the relatively high-load device and/or at the dedicated breaker. The individual electric power provided to the relatively low-load devices connected to electrical outlets can be controlled at the outlet and/or in the relatively low-load device. It is typically not practical to control power to the relatively low-load devices at a breaker that serves more than one device.

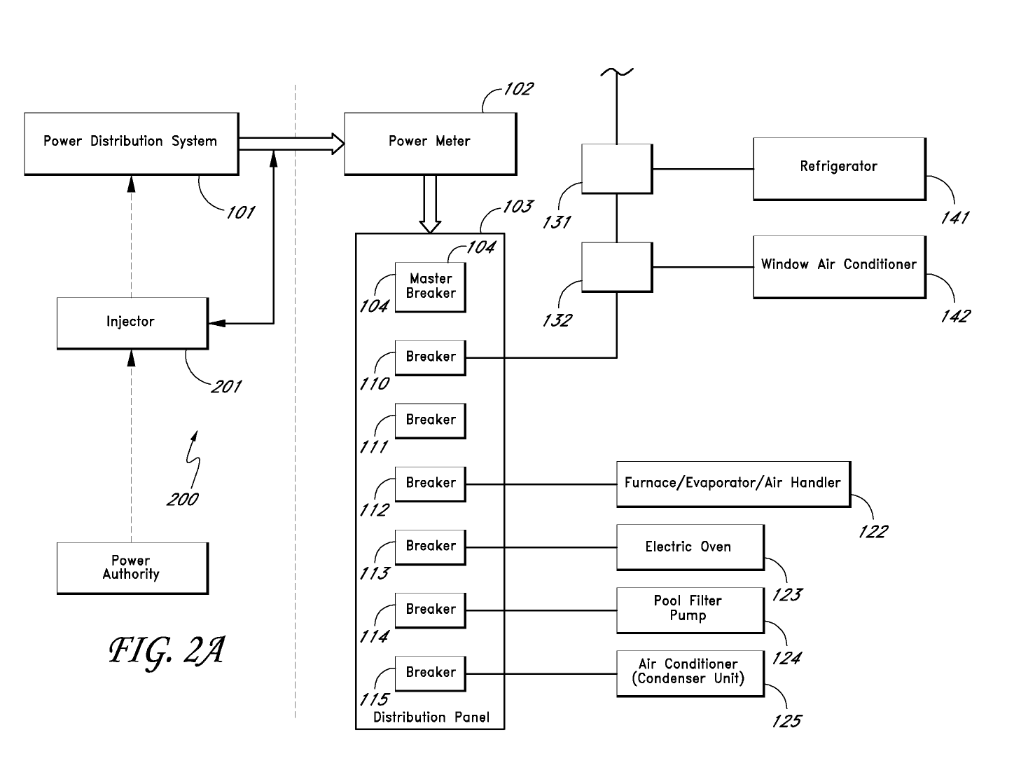

FIG. 2A shows a power distribution system 200 for a home or commercial structure wherein an injector 201 provides power line communications. The injector 201 inserts modulated data signals onto the power line at frequencies other than the 60 Hz (or 50 Hz) frequency used by the power line. In broadband applications, such as, for example, Broadband Power Line (BPL) communications, the data signals are modulated onto carriers in the megahertz range and higher. In medium-bandwidth systems, the carrier frequencies are in the band between approximately a kilohertz range and a megahertz. In relatively low-bandwidth systems, the carriers operate at frequencies below a kilohertz. The relatively high-bandwidth, medium bandwidth, and relatively low-bandwidth systems can typically operate simultaneously without interfering with one another as long as the frequency ranges used by the systems do not overlap. Thus, for example, BPL can typically operate in the presence of a medium-bandwidth system that uses carriers in the frequencies below those used by BPL. Similarly, the medium bandwidth system can typically operate in the presence of a low-bandwidth system that uses frequencies below those used by the medium-bandwidth system.

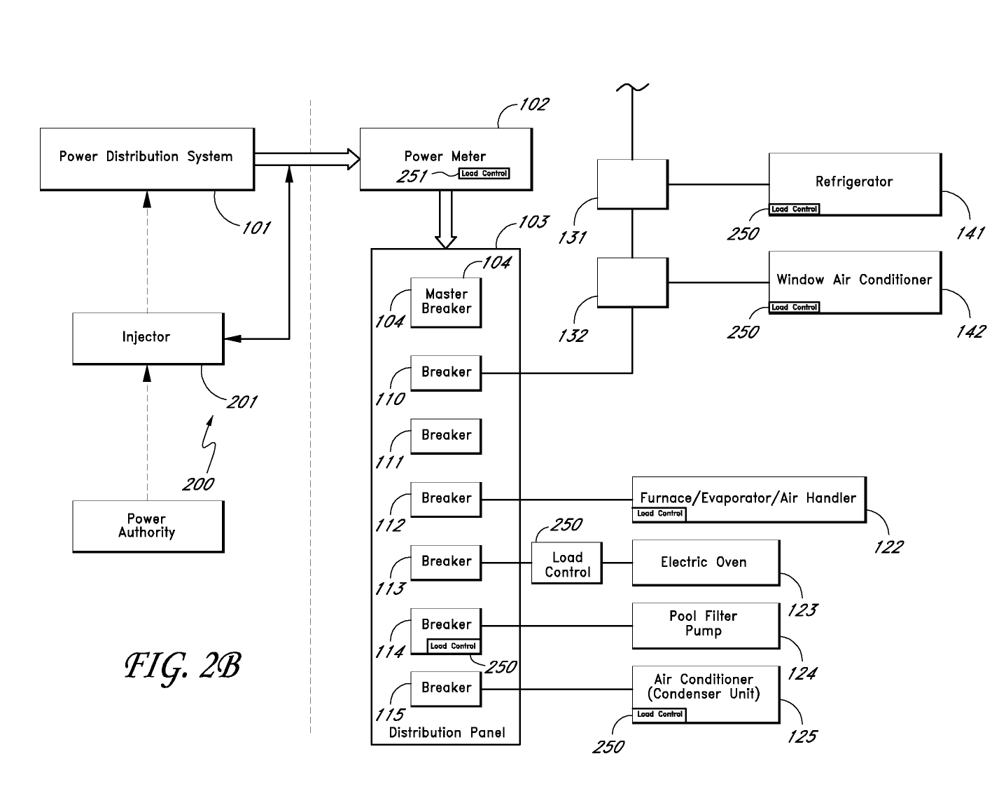

FIG. 2B shows a power distribution system for a home or commercial structure wherein load-control modules 250 are provided to allow the power authority to shed power system loads by remotely switching off certain electrical equipment. The power authority can send commands to the load control modules to shut off electrical equipment by type and/or by identification number. Embodiments of the load-control modules are described in connection with FIGS. 3-5 and 7-10. In one embodiment, a load monitoring module 251 is provided to monitor and control power provided to the distribution box 103.

FIG. 3 shows a load-control device 300 that controls power to a relatively high-load device. In the device 300, electrical power inputs 320, 321 are provided to a modem 301, to a power supply 302, and to a power relay 309. Data from the modem is provided to a processing system 304 that includes a memory 305. In one embodiment, the memory 305 is a non-volatile memory. An optional programming interface 306 (also known as a data interface) is provided to the processing system 304. An optional Radio Frequency (RF) transceiver 307 (having an antenna 308) is provided to the processing system 304. The modem 301, the programming interface 306, and the transceiver 307 provide data interfaces to the processing system 304.

Although referred to herein as a transceiver, when one-way communication is desired, the transceiver 307 can be configured as a receiver for a receive-only system, or a transmitter for a transmit-only system. When configured as a receive-only system, the transceiver 307 can be used to receive instructions from the power authority. When configured as a transmit-only system, the transceiver 307 can be used to send data and/or status information to the power authority. When configured as a transmit/receive system for two-way communication, the transceiver 307 can be used to receive instructions from the power authority and to send data and/or status information to the power authority.

A control output from the processing system 304 is provided to a control input of the power relay 309. In one embodiment, the power relay 309 includes a solid-state relay or other electronically-controlled switch. In one embodiment, the power relay 309 includes a solid-state relay using high-power solid state devices (e.g., triacs, Insulated Gate Bipolar Transistors, Power MOSFETS, etc.). In one embodiment, the power relay 309 includes a mechanical relay. In one embodiment, the power relay 309 is part of a circuit-breaker mechanism that allows the circuit breaker to be switched on and off electrically. In one embodiment, the relay 309 is configured as a double-pole relay that switches the connection between the input terminal 320 and the output terminal 330 as well as the connection between the input terminal 321 and the output terminal 331. In one embodiment, the input terminal 321 is provided to the output terminal 331 and the relay 309 is configured as a single-pole relay that switches the connection between the input terminal 320 and the output terminal 330. In one embodiment, the load-control device is configured as a replacement for a double-pole circuit breaker.

In one embodiment, the modem 301 facilitates one-way communication, to allow the processing system 304 to receive instructions and/or data from the injector 201 or other power line communication device. In one embodiment, the modem 301 facilitates two-way communication, to allow the processing system 304 to receive instructions and/or data from the injector 201 or other power line communication device and to send data to the injector 201 or to other power line communication devices.

The optional programming interface 306 can be configured as a computer port, such as, for example, a Universal Serial Bus (USB) port, a firewire port, an Ethernet port, a serial port, etc. In one embodiment, connection to the programming interface is 306 is provided by an external connector. In one embodiment, connection to the programming interface is provided by a magnetic coupling, a capacitive coupling, and/or an optical coupling (e.g., an InfraRed (IR) coupling, a visible light coupling, a fiber optic connector, a visible light coupling, etc.). The optional programming interface 306 can be configured to provide program code, identification codes, configuration codes, etc. to the programming system 304 and/or to read data (e.g., programming code, identification codes, configuration data, diagnostic data, log file data, etc.) from the programming system 304.

The optional RF transceiver 307 can be configured to provide communication with the processing system 304 through standard wireless computer networking systems, such as, for example, IEEE 802.11, bluetooth, etc. The optional RF transceiver 307 can be configured to provide communication with the processing system 304 through proprietary wireless protocols using frequencies in the HF, UHF, VHF, and/or microwave bands. The optional RF transceiver 307 can be configured to provide communication using cellular telephone systems, pager systems, on subcarriers of FM or AM radio stations, satellite communications, etc. with the processing system 304 through proprietary wireless protocols using frequencies in the HF, UHF, VHF, and/or microwave bands. In one embodiment, the antenna 308 is electromagnetically coupled to one or more electric circuits wires (such as for example, the power input lines 320 or 321, or other nearby electrical power circuits) so that the power circuits can operate as an antenna.

The modem 301 receives modulated power line data signals from the power inputs 320, 321, demodulates the signals, and provides the data to the processing system 304. The processing system 304 controls the relay 309 to provide power to the output lines 330, 331. The output lines 330, 331 are provided to the electrical equipment controlled by the load-control device 300.

In one embodiment, the programming system 304 uses the memory 305 to keep a log file recording commands received and/or actions taken (e.g., when the relay 309 was turned on and off, how long the relay 309 was off, etc.). In one embodiment, the programming interface 306 can be used to read the log file. In one embodiment, the log file can be read using the modem 301. In one embodiment, the log file can be read using the RF transceiver 307. In one embodiment, data from the log file can be read using an Automatic Meter Reading (AMR) system. In one embodiment, an AMR system interfaces with the processing system 304 via the modem 301, the programming interface 306 and/or the transceiver 307.

In one embodiment, fraudulent use, malfunctions, and/or bypassing of the load-control device is detected, at least in part, by reviewing the log file stored in the memory 305. The power authority knows when shutdown instructions were issued to each load-control device. By comparing the known shutdown instructions with the data in the log file, the power authority can determine whether the load-control device shut down the electrical equipment as instructed.

The load-control device 300 can be built into the relatively high-load device. The load-control device 300 can be added to a relatively high-load device as a retrofit. In one embodiment, the load-control device 300 is built into a circuit breaker, such as, for example, the double-pole circuit breakers 112-115 that provide power to a relatively high-load device.

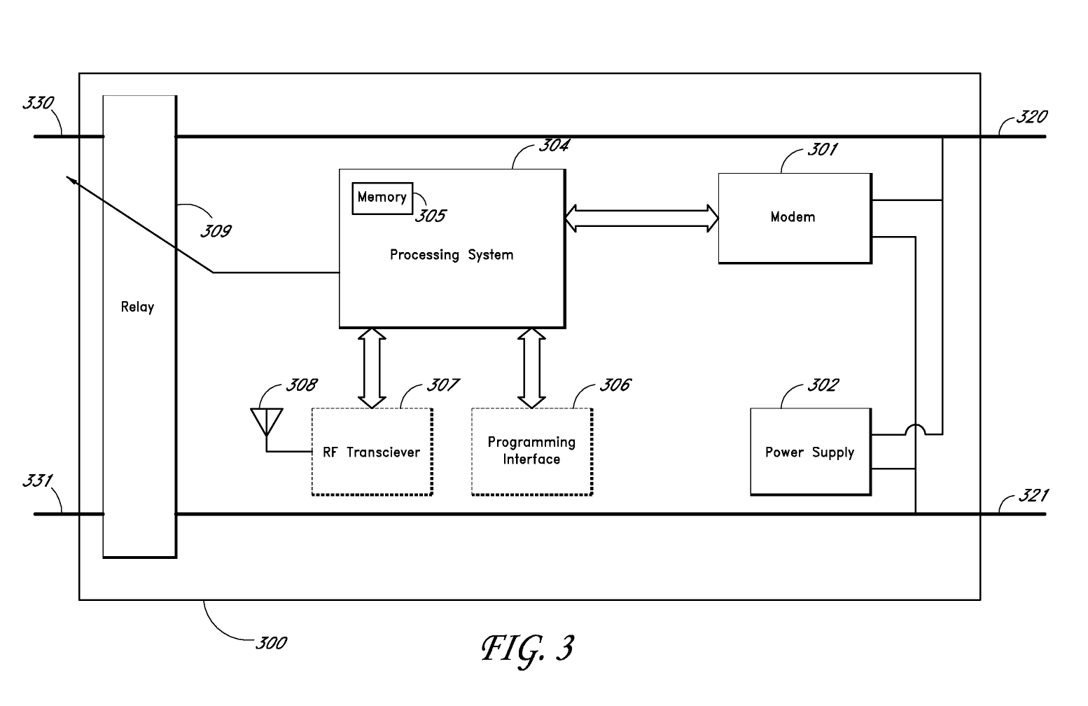

FIG. 4 shows a load-control and power monitoring device 400 that controls power to a relatively high-load device and that monitors power to the device. The system 400 is similar to the system 300, and includes the electrical power inputs 320, 321, the modem 301, the power supply 302, the power relay 309, the processing system 304 and the memory 305, the optional programming interface 306, and the optional RF transceiver 307. In the system 400, a voltage sensor 401 measures the voltage provided to the terminals 330, 331 and a current sensor 402 measures the current provided to the terminal 330. The voltage and current measurements from the sensors 401, 402 are provided to the processing system 304.

The load-control and power monitoring device 400 measures voltage and current at the output terminals 330, 331. Thus, the device 400 can monitor and track the amount of power delivered to the load. In one embodiment, the device 400 keeps a log of power provided to the load in the log file stored in the memory 305.

The sensors 401, 402 are configured to measure electric power. In one embodiment, the sensor 401 measures voltage provided to a load and power is computed by using a specified impedance for the load. In one embodiment, the sensor 402 measures current provided to the load and power is computed by using a specified impedance or supply voltage for the load. In one embodiment, the sensor 401 measures voltage and the sensor 402 measures current provided to the load and power is computed by using a specified power factor for the load. In one embodiment, the sensor 401 measures voltage and the sensor 402 measures current, and power provided to the load is computed using the voltage, current, and the phase relationship between the voltage and the current.

Voltage should not occur at the output terminals 330, 331 when the relay 309 is open. Thus, in one embodiment, the device 400 detects tampering or bypassing by detecting voltage at the output terminals 330, 331 when the relay 309 is open. In one embodiment, the modem 301 provides two-way communication and the processing system 304 sends a message to the power authority when tampering or bypassing is detected.

Similarly, the current sensor 402 should detect current from time to time when the relay 309 is closed (assuming the electrical equipment provided to the output terminals 330, 331 is operational). Thus, in one embodiment, the device 400 detects the possibility of tampering or bypassing by sensing that current has been delivered to the attached equipment on a schedule consistent with the type of attached equipment.

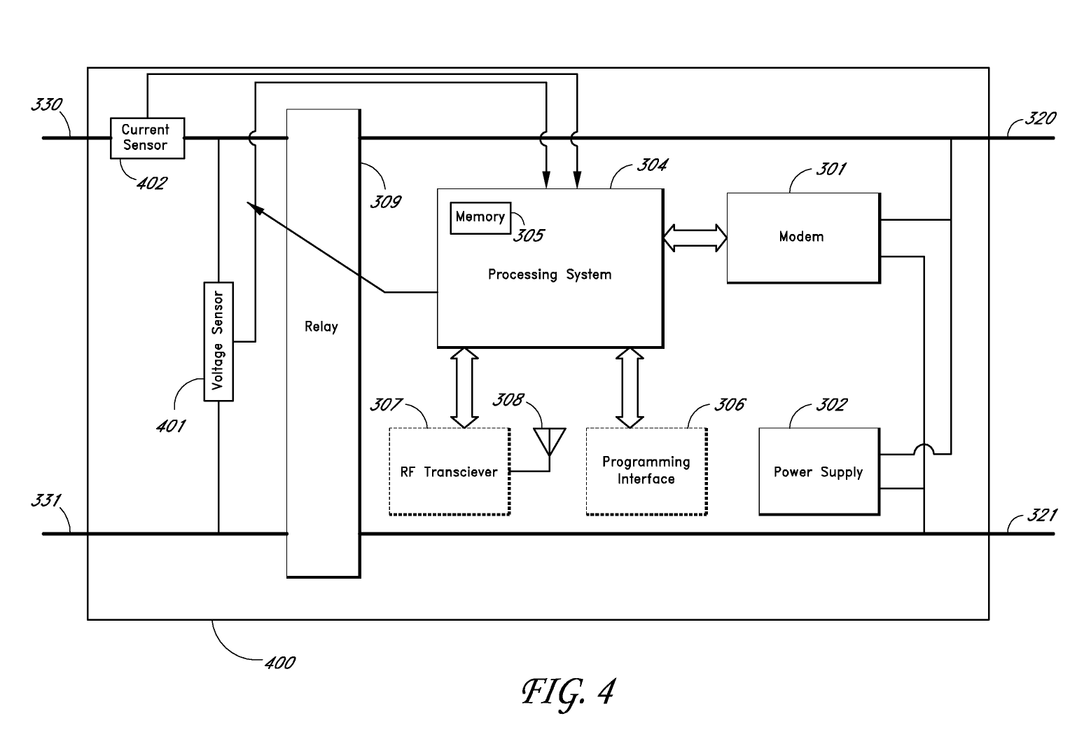

FIG. 5 shows a load-control and power monitoring device for controlling a relatively high-load device using relatively low power control, such as, for example, thermostat control lines. The system 500 is similar to the system 300 and includes the electrical power inputs 320, 321, the modem 301, the power supply 302, the processing system 304 and the memory 305, the optional programming interface 306, and the optional RF transceiver 307. In the system 500, the power relay 309 is replaced by a relatively low-voltage relay 509. Relay outputs 530, 531 can be used in connection with low-voltage control wiring (e.g., thermostat wiring, power relay control inputs, etc.) to control operation of a relatively high-load device.

In one embodiment, the load-control device 500 (or the load-control devices 300, 400) allow the power authority to switch an electrical equipment device such as an air-conditioner into a low-power mode. For example, many higher-quality building air-conditioner systems have one or more low-power modes where the compressor is run at a lower speed. Thus, in one embodiment, the power authority can use the load-control device 500 to place the controlled electrical equipment in a low-power mode or into a shutdown mode. In one embodiment, a plurality of relays 509 is provided to allow greater control over the controlled device. Thus, for example, in one embodiment a first relay 509 is provided to signal the controlled device to operate in a low-power mode, and a second relay 509 is provided to signal the controlled device to shut down. Alternatively, two or more load-control devices 500 can be used for a single piece of electrical equipment. In one embodiment, a first load-control device having a first identification code is provided to signal the electrical equipment to operate in a low-power mode, and a second load-control device having a second identification code is provided to signal the electrical equipment to shut down.

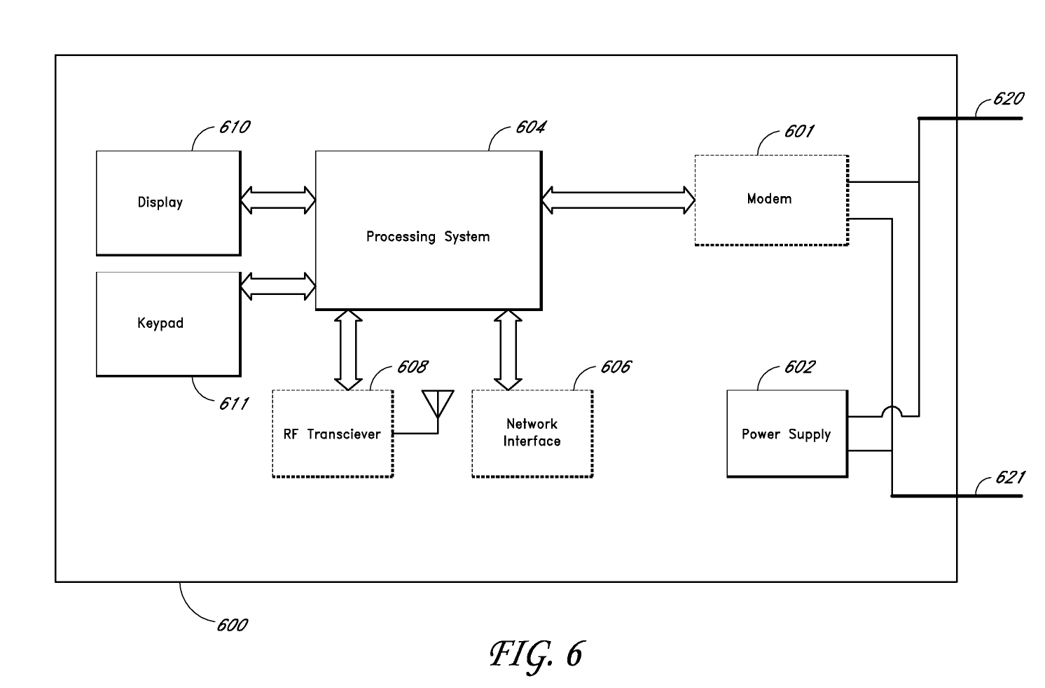

FIG. 7 shows a load-control and power-monitoring device 700 that controls power to a relatively high-load device and monitors current on multiple phases. The system 700 is similar to the system 400, and includes the electrical power inputs 320, 321, the modem 301, the power supply 302, the power relay 309, the processing system 304 and the memory 305, the optional programming interface 306, the optional RF transceiver 307, and the sensors 401, 402. In the system 700, a second current sensor 702 is provided to the processor 304. The second current sensor 702 measures the current provided to the terminal 331.

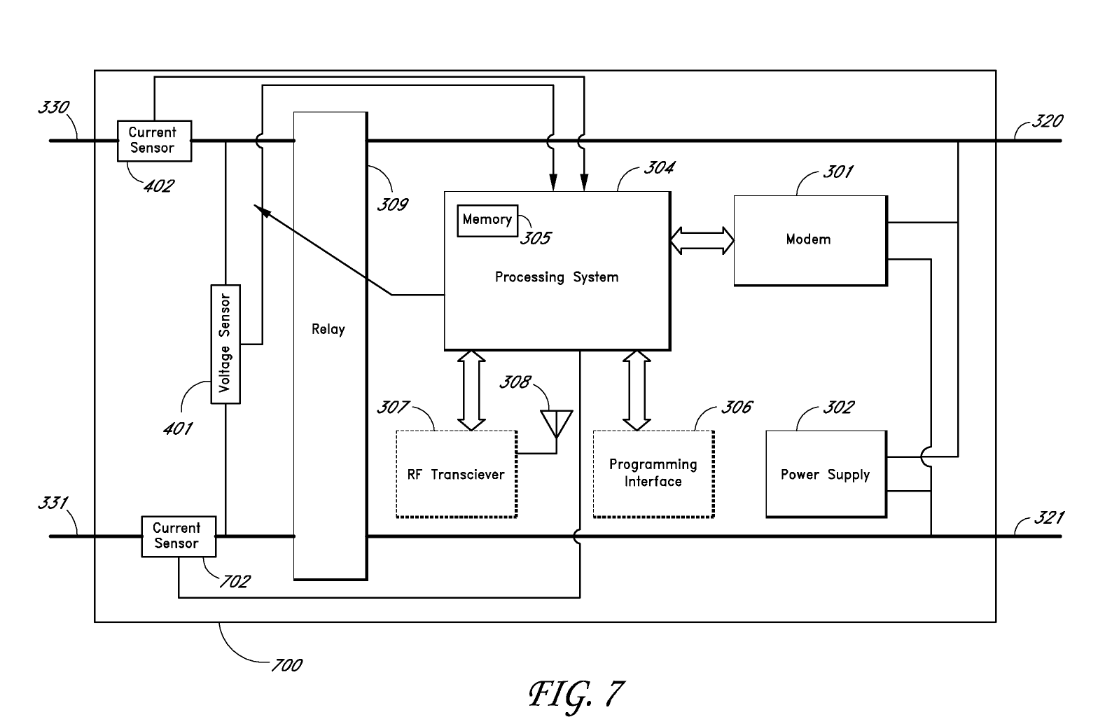

FIG. 8 shows a load-control and power-monitoring device 800 that controls power to a relatively high-load device and that provides circuit breaker overload protection. The system 800 is similar to the system 700, and includes the electrical power inputs 320, 321, the modem 301, the power supply 302, the power relay 309, the processing system 304 and the memory 305, the optional programming interface 306, the optional RF transceiver 307, and the sensors 401, 402, 702. In the system 800, the input terminals 320 and 321 are provided to a double-pole circuit breaker 801. Respective outputs of the double-pole circuit breaker 801 are provided to the modem 301, the power supply 302, and the relay 309. When the circuit breaker 801 trips, the modem 301, the power supply 302, and the relay 309 are disconnected from the electric power inputs 320, 321.

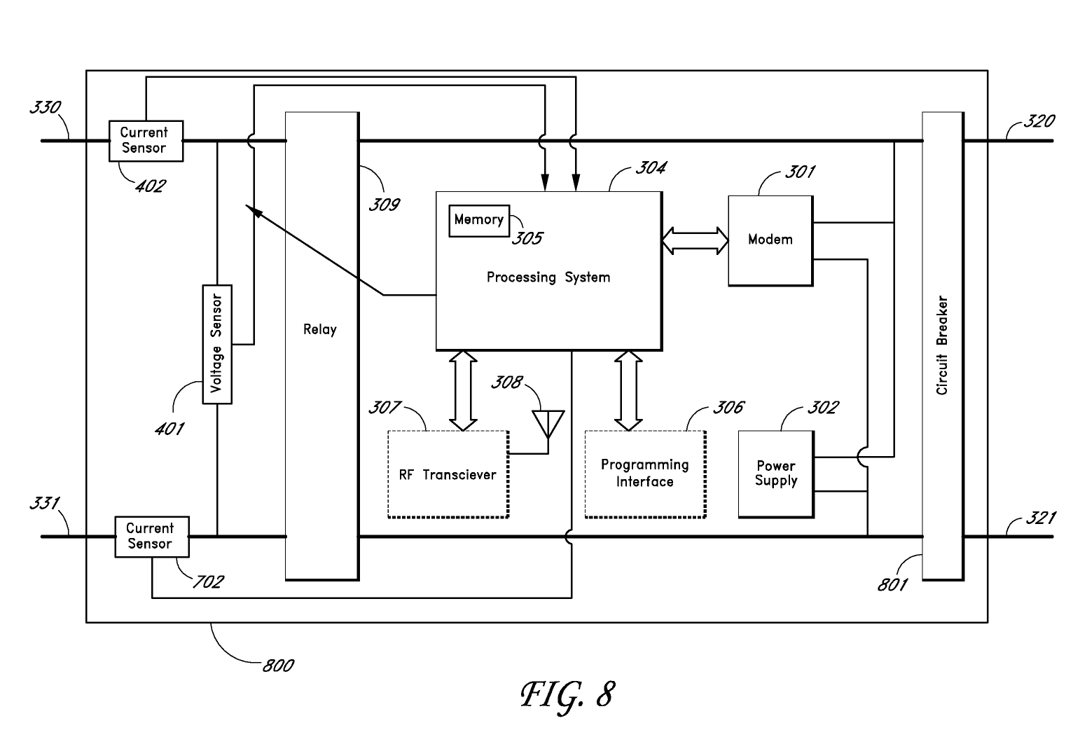

FIG. 9 shows a load-control and power-monitoring device 900 that controls power to a relatively high-load device and that provides circuit breaker overload protection with electric trip. The system 900 is similar to the system 700, and includes the electrical power inputs 320, 321, the modem 301, the power supply 302, the power relay 309, the processing system 304 and the memory 305, the optional programming interface 306, the optional RF transceiver 307, and the sensors 401, 402, 702. In the system 900, the input terminals 320 and 321 are provided to a double-pole circuit breaker 801. Respective outputs of the double-pole circuit breaker 901 are provided to the modem 301, the power supply 302, and the relay 309. When the circuit breaker 901 trips, the modem 301, the power supply 302, and the relay 309 are disconnected from the electric power inputs 320, 321. The circuit breaker 901 trips due to current overload in typical circuit-breaker fashion. In addition, an electric trip output from the processing system 304 is provided to an electric trip input of the circuit breaker 901 to allow the processing to tip the breaker 901. In one embodiment, the processing system 304 trips the breaker 901 when an over-current condition is detected by one or more of the current sensors 402, 702. In one embodiment, the processing system 304 trips the breaker 901 when a fault condition is detected. In one embodiment, the processing system 304 trips the breaker 901 when a ground-fault condition is detected. In one embodiment, the processing system 304 trips the breaker 901 when tampering is detected. In one embodiment, the processing system 304 trips the breaker 901 when an over-voltage condition is detected by the voltage sensor 401. In one embodiment, the processing system 304 trips the breaker 901 when a trip command is received via the modem 301. In one embodiment, the processing system 304 trips the breaker 901 when a trip command is received via the programming interface 306. In one embodiment, the processing system 304 trips the breaker 901 when a trip command is received via the RF transceiver 307. In one embodiment, the processing system 304 trips the breaker 901 when a fault is detected in the relay 309 (for example, the voltage sensor 401 can be used to detect when the relay 309 fails to open or close as instructed by the processing system 305).

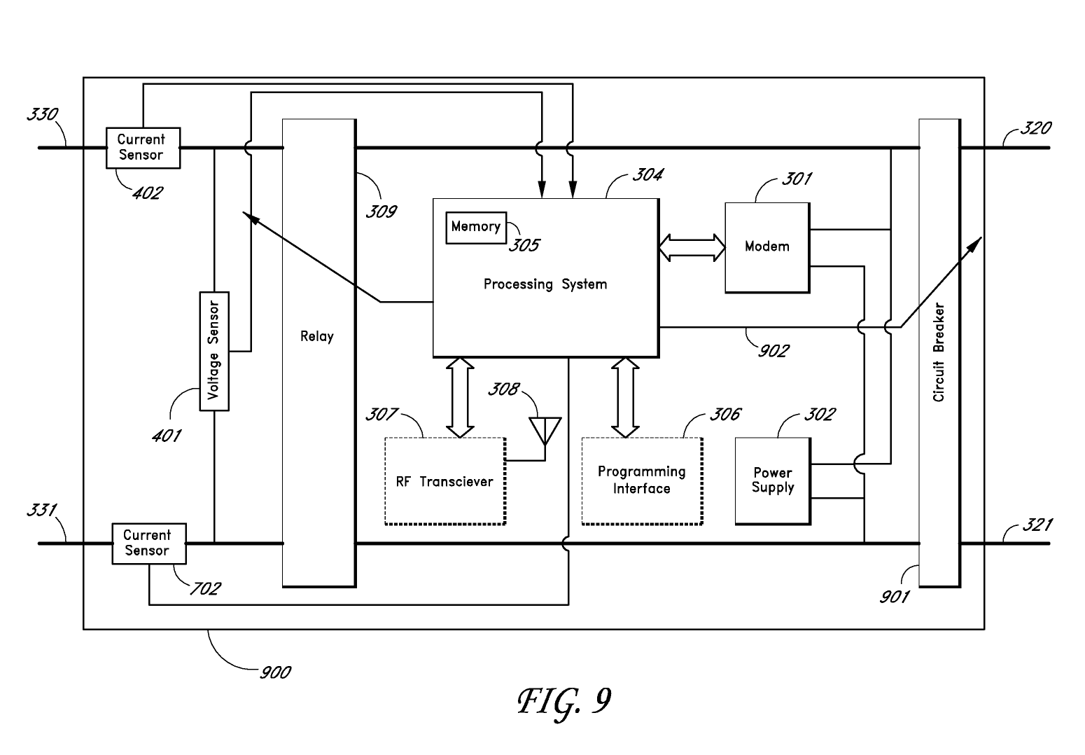

FIG. 10 shows a single-phase load-control and power-monitoring device 1000 that controls power to a relatively high-load device. The single-phase device 1000 is similar to the device 900 except that the relay 309 is replaced by a single-phase relay 1009, the double-phase breaker 901 is replaced by a single-phase breaker 1001. The input 320 is provided to the single-phase breaker 1001. A neutral line input 1021 and the single-phase output from the breaker 1001 are provided to the modem 301 and the power supply 302. The single-phase output from the breaker 1001 is provided to the single-phase relay 1009.

In one embodiment, the processing system 304 is provided with an identification code. In one embodiment, the identification code identifies the controlled electrical equipment provide to the terminals 330, 331 (or 530,531) and thus allows the load-control devices 250 to be addressed so that multiple pieces of electrical equipment can be controlled by providing one or more load-control devices to control each piece of electrical equipment. In one embodiment, the identification code is fixed. In one embodiment, the identification code is programmable according to commands received through the modem 301. In one embodiment, the identification code is programmable according to commands received through the programming interface 306. In one embodiment, the identification code is programmable according to commands received through the RF transceiver 307.

In one embodiment, the identification code used by the processing system 304 includes a device-type that identifies the type of equipment provided to the output terminals 330, 331 (or 530, 531). Thus, for example, in one embodiment the device-type specifies a type of device, such as, for example, a pool filter pump, an electric oven, an electric range, an electric water heater, a refrigerator, a freezer, a window air-conditioner, a building air-conditioner, etc. Relatively low-priority devices such as pool filter pumps can be shut down by the power authority for relatively long periods of time without harmful impact. Power overloads usually occur during the afternoon when temperatures are highest. Pool filter pumps can be run at night when temperatures are cooler and there is less stress on the power system. Thus, in one embodiment, the power authority can instruct the load-control devices having a device-type corresponding to a pool filter pump to shut down for relatively many hours, especially during the daytime.

In one embodiment, the identification code includes a region code that identifies a geographical region. In one embodiment, the identification code includes an area code that identifies a geographical area. In one embodiment, the identification code includes one or more substation codes that identify the substations that serve power to the processing system 304. In one embodiment, the identification code includes one or more transformer codes that identify the transformers that serve power to the processing system 304.

Other relatively high-load devices such as, for example, electric ovens, electric ranges, and/or electric water heaters, are perhaps more important than pool filter pumps, but relatively less important than air conditioners during the hottest part of the day (when power loads tend to be highest). Thus, if shutting down pool filter pumps, does not sufficiently reduce power usage, the power authority can then instruct the load-control devices having a device-type corresponding to such devices to shut down for extended periods of time, especially during the hottest part of the day, in order to reduce power usage. Such equipment can be shut down on a rolling basis over relatively limited areas or over a wide area. The shutdown of such equipment is perhaps more inconvenient than shutting down a pool filter pump, but less inconvenient that shutting down air-conditioners or refrigerators.

If, after shutting down less important equipment, the power system is still overloaded, the power authority can proceed to shut down relatively more important equipment, such as building air-conditioners, window air-conditioners, etc. Such relatively important equipment can be shut down for limited periods of time on a rolling basis in order to limit the impact.

In one embodiment, the system sensors 402, 702 and/or the voltage sensor 401 to measure and track the power provided to the attached device. The processing system 304 uses the sensor data to calculate system efficiency, identify potential performance problems, calculate energy usage, etc. In one embodiment, the processing system 304 calculates energy usage and energy costs due to inefficient operation. In one embodiment, the processing system 304 provides plots or charts of energy usage and costs. In one embodiment, the processing system 304 provides plots or charts of the additional energy costs due to inefficient operation of the attached electrical device.

In one embodiment, the processing system 304 monitors the amount of time that the controlled electrical equipment has been running (e.g., the amount of runtime during the last day, week, etc.), and/or the amount of electrical power used by the controlled electrical equipment. In one embodiment, the power authority can query the processing system 304 to obtain data regarding the operation of the controlled equipment. The power authority can use the query data to make load balancing decisions. Thus, for example the decision regarding whether to instruct the controlled equipment to shut down or go into a low power mode can be based on the amount of time the system has been running, the home or building owner's willingness to pay premium rates during load shedding periods, the amount of power consumed, etc. Thus, for example a homeowner who has a low-efficiency system that is heavily used or who has indicated an unwillingness to pay premium rates, would have his/her equipment shut off before that of a homeowner who has installed a high-efficiency system that is used relatively little, and who had indicated a willingness to pay premium rates. In one embodiment, in making the decision to shut off the controlled equipment, the power authority would take into consideration the relative importance of the controlled equipment, amount of time the controlled equipment has been used, the amount of power consumed by the controlled equipment, etc. In one embodiment, higher-efficiency systems are preferred over lower-efficiency systems (that is, higher-efficiency systems are less likely to be shut off during a power emergency), and lightly-used systems are preferred over heavily-used systems (that is, lightly-used systems are less likely to be shut off during a power emergency).

In one embodiment, the power authority knows the identification codes or addresses of the load-control devices and correlates the identification codes with a database to determine whether the load-control device is serving a relatively high priority client such as, for example, a hospital, the home of an elderly or invalid person, etc. In such circumstances, the power authority can provide relatively less cutback in power provided.

In one embodiment, the power authority can communicate with the load-control devices to turn off the controlled equipment. The power authority can thus rotate the on and off times of electrical equipment across a region to reduce the power load without implementing rolling blackouts. In one embodiment, the load-control device is configured as a retrofit device that can be installed in a condenser unit to provide remote shutdown. In one embodiment, the load-control device is configured as a retrofit device that can be installed in a condenser unit to remotely switch the condenser-unit to a low power (e.g., energy conservation) mode. In one embodiment, the load-control device is configured as a retrofit device that can be installed in an evaporator unit to provide remote shutdown or to remotely switch the system to a lower power mode. In one embodiment, the power authority sends separate shutdown and restart commands to one or more load-control devices. In one embodiment, the power authority sends commands to the load-control devices to shutdown for a specified period of time (e.g., 10 min, 30 min, 1 hour, etc.) after which the system automatically restarts. In one embodiment, the specified period of time is randomized by the processor 304 to minimize power surges when equipment restarts. In one embodiment, the specified period of time is randomized according to a percentage (e.g., 5% randomization, 10% randomization, etc.)

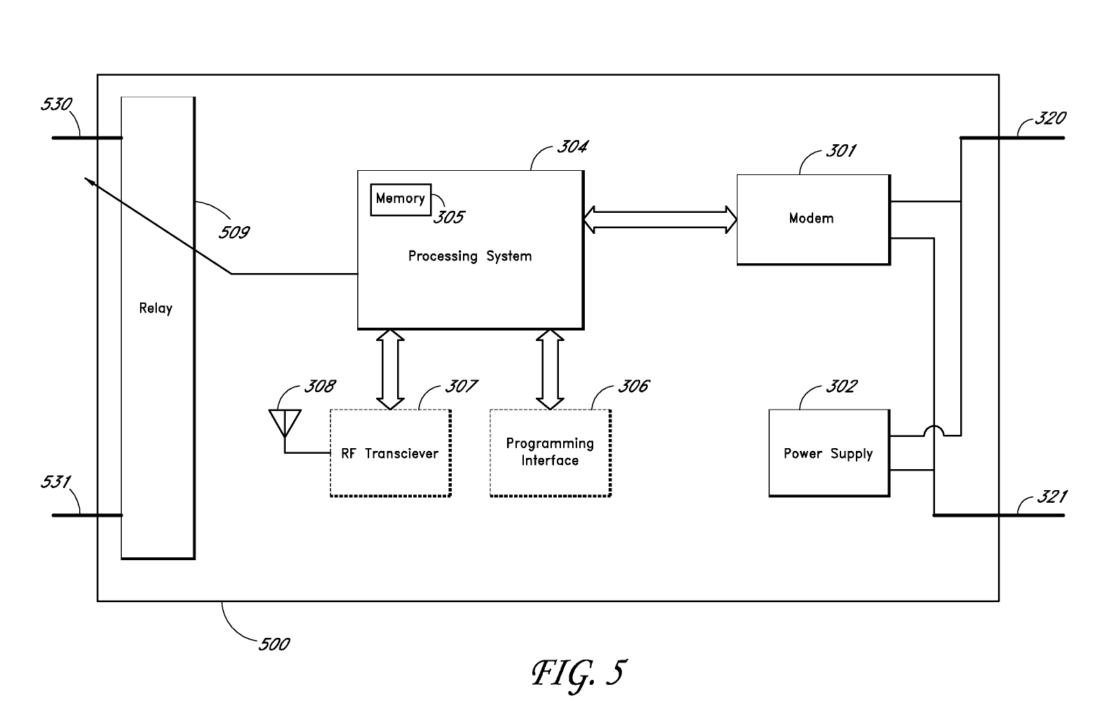

FIG. 6 shows a display system 600 for monitoring the load-control devices 300, 400, 500 in a home or building. In the device 600, electrical power inputs 620, 621 are provided to an optional modem 601 and to a power supply 602. Data from the modem 601 is provided to a processing system 604. An optional programming interface 606 is provided to the processing system 604. An optional Radio Frequency (RF) transceiver (having an antenna 608) is provided to the processing system 604. A display 610 and a keypad 611 are provided to the processing system 604.

In one embodiment, the system 600 can be configured as a computer interface between the load-control devices and a computer, such as a personal computer, monitoring computer, PDS, etc. In one embodiment of the display system 600, when used as an interface to a computer, the display 610 and keypad 611 can be omitted since the user can use the computer display and keyboard, mouse, etc.

In one embodiment, the modem 601 facilitates one-way communication, to allow the processing system 604 to receive instructions and/or data from the injector 201, from the load-control devices or from other power line communication devices. In one embodiment, the modem 601 facilitates two-way communication, to allow the processing system 604 to exchange instructions and/or data with the injector 201, the load-control devices or other power line communication devices.

The optional programming interface 606 can be configured as a computer port, such as, for example, a Universal Serial Bus (USB) port, a firewire port, an Ethernet port, a serial port, etc. In one embodiment, connection to the programming interface is 606 is provided by an external connector. In one embodiment, connection to the programming interface is provided by a magnetic coupling, a capacitive coupling, and/or an optical coupling (e.g., an InfraRed (IR) coupling, a visible light coupling, a fiber optic connector, a visible light coupling, etc.). The optional programming interface 606 can be configured to provide program code, identification codes, configuration codes, etc. to the programming system 604 and/or to read data (e.g., programming code, identification codes, configuration data, diagnostic data, etc.) from the programming system 604.

The optional RF transceiver 607 can be configured to provide communication with the processing system 604 through standard wireless computer networking systems, such as, for example, IEEE 802.11, bluetooth, etc. The optional RF transceiver 607 can be configured to provide communication with the processing system 604 through proprietary wireless protocols using frequencies in the HF, UHF, VHF, and/or microwave bands. In one embodiment, the antenna 608 is electromagnetically coupled to one or more electric circuits wires (such as, for example, the power input lines 620 or 621, or other nearby electrical power circuits) so that the power circuits can operate as an antenna.

The modem 601 receives modulated power line data signals from the power inputs 620, 621, demodulates the signals, and provides the data to the processing system 604. The processing system displays messages on the display 610 and receives user inputs from the keypad 611. Thus, for example, the system 600 can use the display 610 to display messages from the power authority and/or messages from the load-control devices. The messages proved on the display 610 can relate to the power status of the various equipment controlled by load-control devices, such as, for example, power line load conditions, which equipment is about to be shut down, which equipment is shut down, how long equipment will be shut down, total power usage, power used by each piece of equipment, etc.

In one embodiment, the programming system 604 obtains data from the log files stored in one or more of the load-control devices. In one embodiment, the display device 600 displays log file data, summaries of log file data, and/or plots of log file data from one or more of the load-control devices.

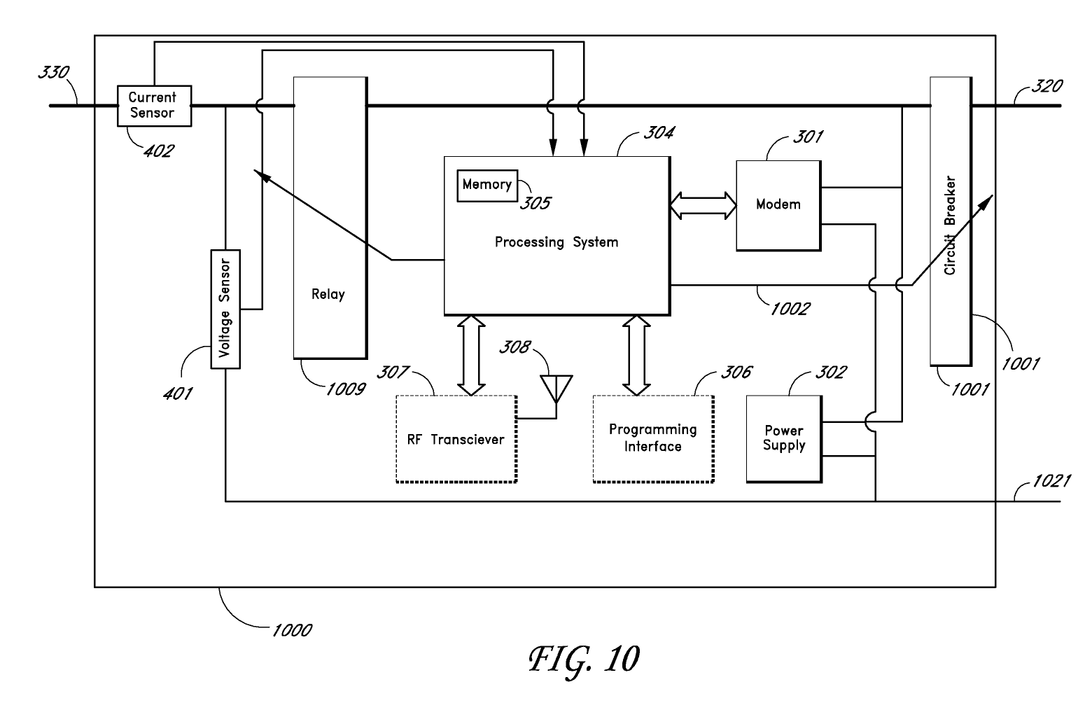

FIG. 11 shows a conventional power meter assembly 1102 that plugs into a meter box 1101 to provide electric service to a home or building. Electric power from the power local power company is provided on an input line 1108 to the meter box 1101. An output line 1109 provides power from the power meter to the distribution box 103. The power meter 1102 includes a conventional electric power meter 1103 used by the local power company to measure power provided to the home or building for billing purposes. When the power meter assembly 1102 is plugged into the meter box 1101, the input 1108 is provided to the power meter 1103, and an output of the power meter 1103 is provided to the output 1109. The power meter 1103 typically includes a series of dials that display the amount of electric power delivered through the meter 1103. In some localities, the power meter 1103 must be read manually. In some localities, the power meter 1103 is configured to be read remotely F using an Automatic Meter Reading (AMR) system.

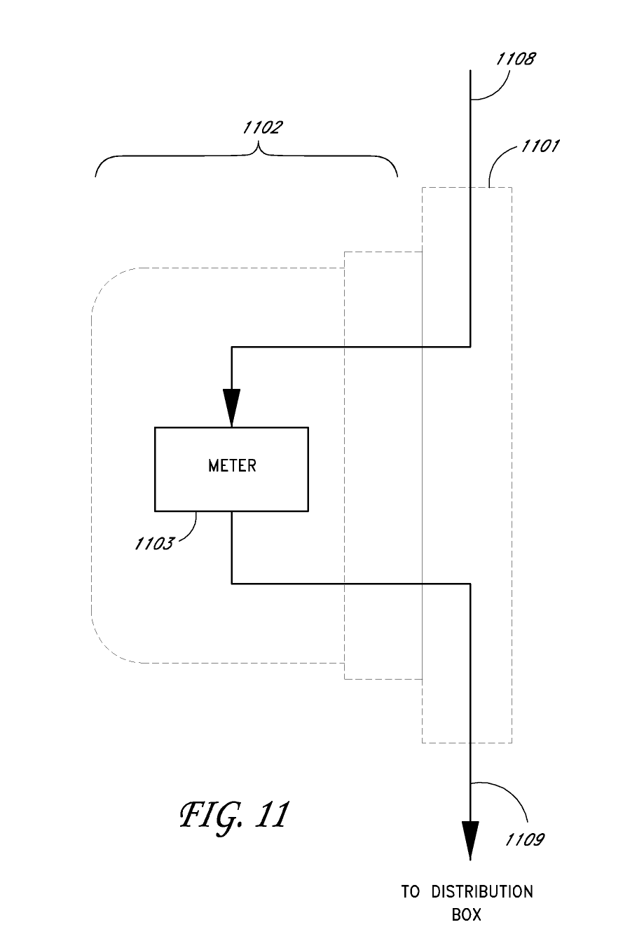

FIG. 12 shows a power meter assembly 1200 with load control capability. The power meter 1200 is configured to plug into the conventional meter box 1101. In the power meter 1200, the input 1108 is provided to a load monitor 1201. An output from the load monitor 1201 is provided to the power meter 1103. The output of the power meter 1103 is provided to the output 1109. One of ordinary skill in the art will recognize that the load monitor 1201 and the meter 1103 can be reversed such that the input 1108 is provided to the power meter 1103, the output from the power meter 1103 is provided to the load monitor 1201, and the output from the load monitor 1201 is provided 1201 is provided to the output 1109. The load monitor 1201 can also be provided inside the meter box 1201 or the box housing the distribution panel 103.

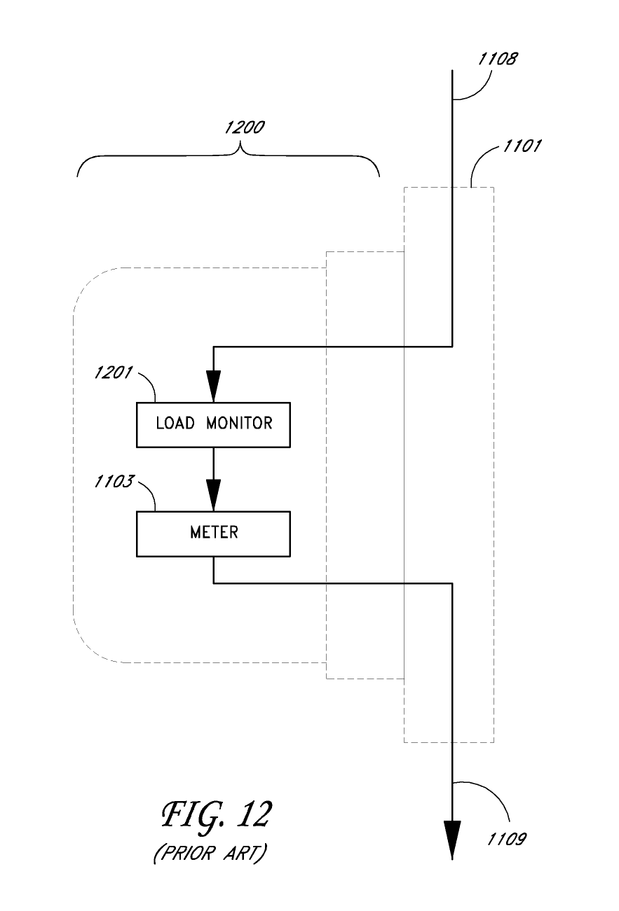

FIG. 13 shows a load control assembly 1300 for use in connection with a standard power meter assembly 1102. The load control assembly 1300 is configured to plug into the conventional power meter box 1101. The load control assembly 1300 provides a conventional receptacle such that the standard power meter assembly 1102 can then be plugged into the load control assembly 1300. In the load control assembly, the input 1108 is provided to the load monitor 1201. An output from the load monitor 1201 is provided to the power meter assembly 1102. The output of the power meter assembly 1102 is provide, via the assembly 1300, to the output 1109. One or ordinary skill in the art will recognize that the load monitor 1201 and the meter 1103 can be reversed such that the input 1108 is provided, via the assembly 1300, to the power meter 1103, the output from the power meter 1103 is provided to the load monitor 1201, and the output from the load monitor 1201 is provided 1201 is provided to the output 1109.

The load monitor 1201 provides load control and monitoring as described in connection with FIGS. 3-5 and/or 7-10. In one embodiment, the power authority sends instructions to the load monitor 1201 using power line networking via the modem 301. In one embodiment, the power authority sends instructions to the load monitor 1201 using power line networking via programming interface 306 (e.g., through a wired network connection, telephone connection, cable connection, fiber-optic connection, etc.). In one embodiment, the power authority sends instructions to the load monitor 1201 using wireless transmission via the transceiver 307.

In one embodiment, the load monitor 1201 is provided in the distribution box 103 in series with the master breaker 104. In one embodiment, the load monitor 1201 is provided to the master breaker 104. In one embodiment, the load monitor 1201 is built into the master breaker 104.

In one embodiment, the load monitor 1201 is configured as shown in FIGS. 4 and/or 7-10 and programmed to operate such that the power authority can command the processor 304 to allow no more than a specified maximum amount of power (or current) is delivered through the load monitor 1201. Thus, for example, even if the power meter 102 and master breaker 104 are configured for 200 amp service (as is typical of many residential installations), then during a power shortage, the power authority can instruct the load monitor to open the relay 309 (and thus blackout the home or building served by the load monitor 1201) if the current exceeds a specified maximum (e.g., 20 amps, 30 amps, 50 amps, 100 amps, etc.), during some period of time. In one embodiment, the load monitor 1201 restores power service after a specified period of time. In one embodiment, the load monitor 1201 restores power service after the power authority sends instructions or commands to the load monitor 1201 informing the load monitor 1201 that more power is available. In one embodiment, after receiving commands to reduce power, the load monitor 1201 delays transitioning to low-power mode for a period of time in order to give downstream load control devices, such as the load-control devices 250, time to reduce the power load. In one embodiment, after receiving commands to reduce power, the load monitor 1201 delays transitioning to low-power mode for a period of time in order to give the home or building owner time to reduce the power load.

Thus, the load monitor 1201 provided in the service line can be used with or without the load control devices 250 provided with specified circuits (or loads) in the home or building to provide load control. The load monitor 1201 and/or load control devices 205 can be used on a voluntary basis, in connection with a regulatory scheme, or some combination thereof. For example, a regulatory scheme can be adopted that requires load control devices 250 in certain relatively high-load circuits (e.g., pool filter pumps, electric water heaters, electric ovens, air-conditioners, etc.).

Alternatively, a regulatory scheme can be adopted that requires the load control device 1201 to be installed at the service entrance while leaving it up to the homeowner or building owner to voluntarily install the load control devices 250 in various circuits. Under such a regulatory scheme, a home owner that does not install load control devices 250 in the relatively high-load circuits of the home or building runs the risk of losing service during a power shortage because the load control device 1201 will act like a circuit breaker and “trip” if the owner tries to draw more power than the power authority has authorized during the power shortage. Unlike a regular circuit breaker, in such a regulatory scheme, the load control monitor 1201 can be configured so that it cannot be immediately reset and thus the owner will have to endure a blackout period. Thus, under such a regulatory scheme, it is in the owner's best interests to voluntarily install the load control devices 250 so that the total load through the load monitor device 1201 is less than the allowed load during the power shortage.

In one embodiment, the load monitor device 1201 uses the modem 301, the programming interface 306 and/or the RF transceiver 307 to send status and/or shutdown messages to the load control devices 250 and/or the display device 600. A load control system based on the load monitor device 1201, the load control devices 205, and the display device 600 (or computer) is flexible and can be configured to operate in different ways.

In one embodiment, the load monitor device 1201 receives a load-limit message from the power authority instructing the load monitor device 1201 to limit power or current drawn through the building's electrical service. The load monitor device 1201 then selects the circuits to shut down (based on the allowed current) and sends shutdown commands to the various load control devices 250. In one embodiment, the display system 600 (or computer) also receives the shutdown commands and can format a display showing which devices have been shut down. In one embodiment, the load monitor device 1201 sends one or more status messages to the display system 600 (or computer) to allow the display system 600 inform the owner of the power status (e.g., which devices have been shut down, how long the shutdowns will last, how much power is allowed, etc.)

In one embodiment, the load monitor device 1201 receives a load-limit message from the power authority instructing the load monitor device 1201 to limit power or current drawn through the building's electrical service. The load monitor device 1201 then sends a message to the display system 600 (or computer) informing the display system of the power restriction. The display system 600 (or computer) selects the circuits to shut down (based on the allowed current) and sends shutdown commands to the various load control devices 250. The display system 600 (or computer) formats a display to inform the owner of the power status (e.g., which devices have been shut down, how long the shutdowns will last, how much power is allowed, etc.). In one embodiment, the owner can use the display system 600 (or computer) to select which devices will be shut down and which devices will remain operational. Thus, for example, during an extended power outage, the owner can rotate through the relatively high-load devices first using the air-conditioner (with the hot-water heater shut down) and then using the hot-water heater (with the air-conditioner shut down). The owner can also use the display system 600 (or computer) to establish power priorities and determine the order in which circuits are shut down based on the available power. Thus, for example, in winter, the homeowner can choose to shut down all circuits except the electric heater (or heat pump), while in summer the same homeowner might decide to shut down the air-conditioner before shutting down the electric water heater. Thus, in one embodiment, when the total power is limited by the load monitor device 1201, the homeowner (or building owner) can use the display system 600 (or computer) to make decisions regarding which devices are shut down and in what order. In one embodiment, the display system 600 (or computer) knows the power (or current) drawn by each piece of electrical equipment serviced by a load-control device 250 and thus the display system 600 (or computer) can shut down the required number of devices based on the priorities established by the user (or based on default priorities).

In one embodiment, a regulatory scheme requires load-control devices 250 for all relatively high-load devices in a home or building. In one embodiment, the power authority shuts down the relatively high-load equipment based one a priority schedule (e.g., pool filter pumps first, then ovens and stoves, then electric water heaters, then air-conditioners, then heaters, etc.) until the system load has been sufficiently reduced. In one embodiment, the power authority shuts down the relatively high-load equipment based on location (e.g., first one neighborhood, then another neighborhood) in a rolling fashion until the system load has been sufficiently reduced. In one embodiment, the priority schedule is established by the power authority. In one embodiment, the priority schedule is established by the home or building owner.

In one embodiment, the priority schedule is adaptive such that a group of load control devices 205 negotiate to determine the priority. In one embodiment, heating devices have a relatively higher priority in winter (e.g., less likely to be turned off) and a relatively lower priority in summer.

In one embodiment, a regulatory scheme requires both load monitoring devices 1201 and load-control devices 250.

In one embodiment, the processing system is configured to support encrypted communication through the modem 301, the programming interface 306, and/or the RF transceiver 307 to prevent unauthorized access. In one embodiment, a first encryption is used for communication with the processing system 304 related to load reduction commands such that only the power authority has the ability to send load reduction commands to the processing system 304. In one embodiment, a second encryption is used for communication with the processing system 304 related to status and power usage information so that the home or building owner can use the display system 600 and/or a computer to make inquires to the processing system 304 regarding power usage, power status, etc. Using two different encryptions, allows the power authority to control the processing system 304 to reduce loads on the power system, while still allowing the home or building owner to make inquiries to the processing system 304 (while preventing neighbors and other unauthorized persons to access the system 304).

In one embodiment, the first and second encryptions are provided by using first and second passwords. In one embodiment, the first and second encryptions are provided by using first and second encryption methods.

In one embodiment, encrypted access is provided via one communication method (e.g., through a selected frequency band or bands via modem 301, through one or more access methods provided by the programming interface 306, and/or through a selected frequency band or bands via the transceiver 307. Thus, by way of example, and not by way of limitation, in one embodiment, the processor 304 can be configured such that commands from the power authority are received via the RF transceiver 307, communication with the display system 600 or computer are provided by the modem 301, and configuration of the processing system 304 (e.g., entry of passwords) is provided by communication using the programming interface 306.

In one embodiment, the relay 309 is configured such that when the relay 309 is open, power line networking signals from the modem 301 are still provided to the output terminals 330, 331. In one embodiment, the relay 309 includes a high-pass filter to allow powerline-networking signals from the modem 301 to flow though the relay when the relay is open. In one embodiment, the relay 309 includes a band-pass filter to allow powerline-networking signals from the modem 301 to flow though the relay when the relay is open.

In one embodiment, the circuit breakers 801, 901 are configured such that when the breaker 801, 901 is tripped (open), power line networking signals from the modem 301 are still provided to the input terminals 320, 321. In one embodiment, circuit breakers 801, 901 are bypassed by a high-pass filter to allow powerline-networking to flow through the breaker when the breaker is open. In one embodiment, the circuit breakers 801, 901 include a band-pass filter to allow powerline-networking to flow though the breaker when the breaker is open.

In addition to providing load control for the power authority, the systems described herein can be used for load control by the home or building owner to track power usage and reduce power costs. Thus, for example, when the load monitor device 1201 is configured using embodiments that include the current sensors 402, 702, the load monitor device 1201 can provide current usage (and thus power usage) data to the display system 600 (or computer). When the load-control devices 250 are configured using embodiments that include the current sensors 402 and/or 702, the load-control devices 250 can provide current usage (and thus power usage) data to the display system 600 (or computer) for the electrical equipment serviced by the load-control device. 250.

In one embodiment, the modem 301 is configured to operate in a plurality of powerline networking modes such as, for example, BPL, X10, LonWorks, current carrier, etc. In one embodiment, the modem 301 communicates with the power authority using a first power line networking protocol, and the modem 301 communicates with the display 600 or computer using a second power line networking protocol.

In one embodiment, the modem 301 is omitted. In one embodiment, the transceiver 307 is omitted. In one embodiment, the programming interface 306 is omitted.

In one embodiment, the relay 309 is configured to close in a manner that provides a “soft” restart of the electrical equipment in order to reduce surges on the power line. In one embodiment, the relay 309 is configured as a solid state relay and the processing system 304 controls the solid state relay in a manner that provides a soft restart. In one embodiment, the relay 309 is configured as a solid state relay and the processing system 304 controls the solid state relay in a manner that provides a soft restart by progressively switching cycles of the AC power on the power line.

In one embodiment, the relay 309 is configured to close in a manner that provides a dimmer-like function such that resistive electrical equipment such as for example, electric water heaters, electric ovens and ranges, resistive electric heaters, and the like can be controlled at reduced power levels without be shut completely off. In one embodiment, the relay 309 is configured as a solid state relay and the processing system 304 controls the solid state relay in a manner that provides a dimmer-like function. In one embodiment, the relay 309 is configured as a solid state relay and the processing system 304 controls the solid state relay in a manner that provides a dimmer-like function by progressively switching selected cycles, or portions of cycles, of the AC power on the power line.

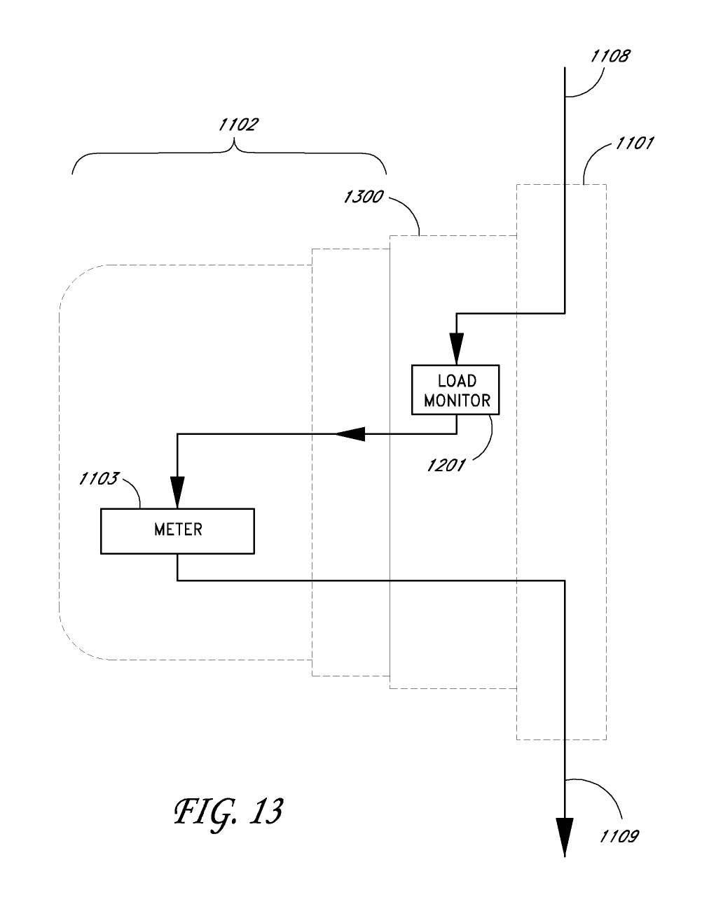

FIG. 14 shows an electric distribution system 1400 with automatic downstream load control. In the system 1400, power is provided to a substation 1401. The substation 1401 provides power to a plurality of substations 1411-1414. Each of the substations 1411-1414 provides power to a plurality of transformers that service homes, neighborhoods, or buildings. In FIG. 14, the substation 1413 provides power to a plurality of transformers 1421-1424. The transformer 1421 provides power to a plurality of homes 1431-1435. A load sensor 1450 is provided to the substation 1413. A load sensor 1451 is provided to the transformer 1421.

When the substation 1413 becomes overloaded (or nears overload), the load sensor 1450 sends load reduction signals to the homes and buildings serviced by the substation 1413. Thus, in FIG. 14, when the load sensor 1450 detects that the substation 1413 is overloaded, the sensor 1450 sends load reduction commands to the homes/buildings serviced by the transformers 1421-1424. In one embodiment, the load sensor 1450 uses powerline networking to send load reduction commands to the homes/buildings serviced by the transformers 1421-1424. In one embodiment, the load sensor 1450 uses wireless transmission to send load reduction commands to the homes/buildings serviced by the transformers 1421-1424. In one embodiment, the load sensor 1450 also informs the power authority that the substation 1413 is overloaded.

When the transformer 1421 becomes overloaded (or nears overload), the load sensor 1451 sends load reduction signals to the homes and buildings serviced by the transformer 1421. Thus, in FIG. 14, when the load sensor 1451 detects that the transformer 1421 is overloaded, the sensor 1451 sends load reduction commands to the homes 1431-1435. In one embodiment, the load sensor 1451 uses powerline networking to send load reduction commands to the homes 1431-1435. In one embodiment, the load sensor 1451 uses wireless transmission to send load reduction commands to the homes 1431-1435.

One method for controlling power usage is to limit the amount of electrical power that can be provided to electrical access points such as light sockets, outlets, etc. For example, it is known that incandescent bulbs are less efficient than compact fluorescent lights. Some governments have attempted to force users to switch to compact fluorescent lights by restricting or prohibiting the sale or incandescent bulbs. Nevertheless, incandescent bulbs are widely available. A power-limiting socket that provides enough power for a compact fluorescent light but not enough power for a typical incandescent bulb will force users to switch to compact fluorescent bulbs even if incandescent bulbs are available. There are also safety considerations that are not met by current lighting fixtures. Many fixtures are designed for a maximum wattage yet capable of receiving bulbs that exceed that wattage. The same is true for electrical outlets. Circuit breakers are commonly used to prevent excess power draw. Circuit breakers however, are confusing to many people.

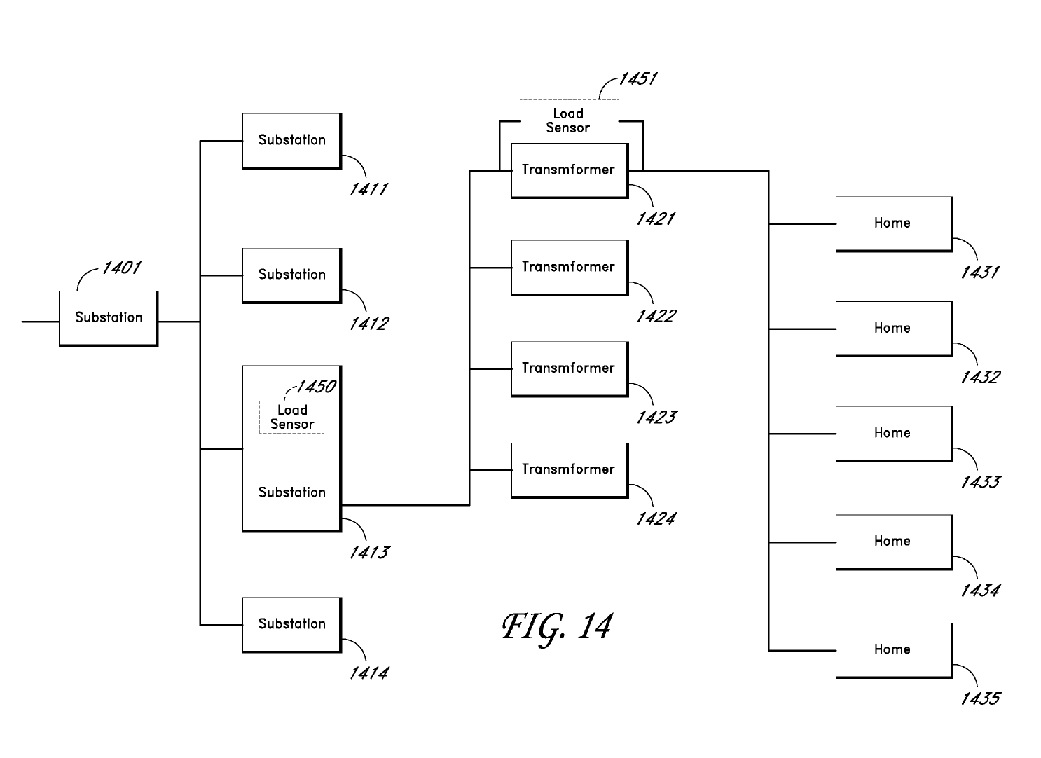

FIG. 15 shows a power-monitoring light socket 1501. The socket 1501 can include an optional visual indicator 1502 and/or an optional manual reset switch 1503.

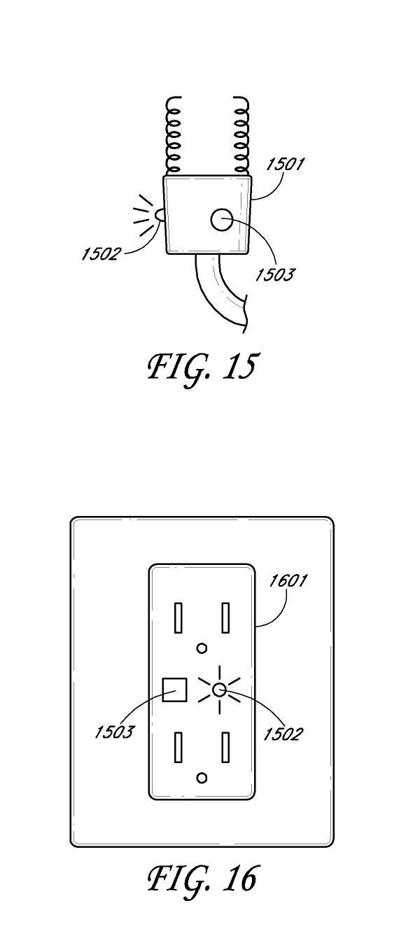

FIG. 16 shows a power-monitoring electrical outlet 1601 having one or more electric sockets. The outlet 1601 can include the optional visual indicator 1502 and/or the optional manual reset switch 1503. The socket 1501 and outlet 1601 include one or more of the power monitoring and control systems as shown and described above in connection with FIGS. 3-10 and can provide any of the functionality described above in connection with FIGS. 3-10.

The socket 1501 and outlet 1601 are configured to limit the amount of power provided to attached loads. In one embodiment, the socket 1501 and outlet 1601 are configured to monitor power provided to attached loads and to interrupt the flow of current to the load (by opening the electrically-controlled switch 309) when the load draws too much power. Unlike circuit breakers, the processing system 304 in the socket 1501 or outlet 1601 can be configured to restore power after a specified period of time.

In one embodiment, an optional visual indicator 1502 such as, for example, an LED or other light-emitting device, is provided to indicate that the state of the socket 1501 or outlet 1601. In one embodiment, the visual indicator 1502 shows a first state (e.g., off, flashing, on, etc.) to show normal operation and a second state (e.g., off, flashing, on, etc.) to show that the socket 1501 and outlet 1601 as temporarily interrupted power flow. In one embodiment, the visual indicator 1502 shows a third state (e.g., off, flashing at a different speed, on, etc.) to show that the socket 1501 and outlet 1601 as interrupted power flow for a longer time period. In one embodiment, an optional manual reset button 1503 is provided to allow the user to restore operation before the timeout period has elapsed. In one embodiment, the visual indicator 1502 shows a third state (e.g., off, flashing at a different speed, on, etc.) to show that the socket 1501 and outlet 1601 as interrupted power flow and the power will not be restored until the user presses the reset button 1503.

In one embodiment, the length of the time period when power flow is interrupted is computed at least in part by the amount by which the power drawn by a light or appliance provided to the socket 1501 or outlet 1601 exceeds the allowed power draw. Thus, for example, if the appliance exceeds the allowed power draw by a relatively small amount then power is interrupted for a relatively short period. Conversely, if the appliance exceeds the allowed power draw by a relatively larger amount then power is interrupted for a relatively longer period. As described above, the visual indicator 1502 can be used to indicate how long the power interruption period will be.

In one embodiment, the socket 1501 or outlet 1601 compares current provided (e.g., current flowing through the terminals 330, 331) to a maximum current for a measurement time period and interrupts power flow when a maximum current has been exceeded for a specified period of time. In one embodiment, the socket 1501 or outlet 1601 waits a first time period (e.g., an initial inrush period) before starting the measurement time period. In one embodiment, the socket 1501 or outlet 1601 waits a period of time after activating the visual indicator before interrupting current flow.

In one embodiment, the socket 1501 or outlet 1601 sends a first message to at least one load-control device before interrupting current flow. In one embodiment, the socket 1501 or outlet 1601 interrupts current flow after a specified amount of power has been provided by said socket during a specified time period. Thus, for example, in such an embodiment the socket 1501 or 1601 can allow a relatively large amount of power to be drawn, but only for a time period such that the total power drawn does not exceed a specified maximum. In one embodiment, the socket 1501 or outlet 1601 activates the visual indicator after a specified amount of power has been provided by said socket during a specified time period.

Although various embodiments have been described above, other embodiments will be within the skill of one of ordinary skill in the art. Thus, the invention is limited only by the claims.

What is claimed is:

1. An apparatus for load control in an electrical power system, comprising:
an electrically-controlled switch configured to control electric power provided to an electric socket;
a current sensor that measures electrical current provided by the electric socket; and
a processing system that opens said electrically-controlled switch to interrupt power provided by the electric socket when electrical current provided by said electric socket exceeds a threshold current for a specified period of time, said processing system configured to close said electrically-controlled switch after said electrically-controlled switch has been open for a specified period of time.

2. The apparatus of claim 1, wherein said threshold current is provided to said processing system via power-line networking.

3. The apparatus of claim 1, wherein said processing system opens said electrically-controlled switch on receipt of a command to shutdown for a specified period of time.

4. The apparatus of claim 1, further comprising a data interface to receive communications and provide communication data to said processing system.

5. The apparatus of claim 4, wherein said data interface device comprises a broadband over power line modem.

6. The apparatus of claim 4, wherein said data interface device comprises a wireless modem.

7. The apparatus of claim 4, wherein said data interface device comprises a computer network interface.

8. The apparatus of claim 1, wherein said data interface device comprises a powerline modem.

9. The apparatus of claim 1, wherein said processing system measures power provided by said electric socket.

10. The apparatus of claim 1, wherein said processing system opens said electrically-operated switch and does not subsequently automatically close said electrically-operated switch if current through said socket exceeds a maximum value.

11. The apparatus of claim 1, wherein said socket comprises a socket for a standard screw-in light bulb.

12. The apparatus of claim 1, wherein said socket comprises a three-pronged electrical outlet.

13. The apparatus of claim 1, wherein said socket comprises a two-pronged electrical outlet.

14. The apparatus of claim 1, further comprising a manual reset switch.

15. The apparatus of claim 1, further comprising a visual indicator to show that the electrically-controlled switch has been opened.

16. The apparatus of claim 1, wherein said processing system compares current provided by said socket to said maximum current after a specified time period.

17. The apparatus of claim 16, wherein said specified time period comprises an initial inrush period.

18. The apparatus of claim 1, wherein said processing device waits a first period of time after activating a visual indicator before opening said electrically-controlled switch.

19. The apparatus of claim 1, wherein said processing system sends a first message to at least one load-control device before opening said electrically-controlled switch.

20. The apparatus of claim 1, wherein said processing system opens said electrically-controlled switch after a specified amount of power has been provided by said socket during a specified time period.

21. The apparatus of claim 1, wherein said processing system activates a visual indicator after a specified amount of power has been provided by said socket during a specified time period.
